(19) United States
(12) Patent Application Publication
(10) Pub. No.: US 2003/0005531 A1
(43) Pub. Date: Jan. 9, 2003

(54) Unmanned vehicle adapted to be used in a stable, such as a cowshed

(75) Inventor: Karel van den Berg, Bleskensgraaf (NL)

Correspondence Address: MASON, MASON & ALBRIGHT, 2306 South Eads Street, P.O. Box 2246, Arlington, VA, 22202-0246, US

(73) Assignee: Lely Research Holding A.G.

(21) Appl. No.: 09/765,385

(22) Filed: Jan. 22, 2001

Related U.S. Application Data
(63) Continuation of application No. PCT/NL00/00312, filed on May 10, 2000.

(30) Foreign Application Priority Data
May 25, 1999 (NL) 1012141

(51) Int. Cl. B08B 1/00

(52) U.S. Cl. 15/3; 15/319; 15/49.1; 134/18; 422/292

(57) ABSTRACT

The invention relates to an unmanned vehicle (1) which is adapted to be used in a stable, such as a cowshed. The unmanned vehicle (1) is provided with a manure displacing device (2) which is capable of being moved to a place at a distance from the vehicle. The manure displacing device (2) comprises a manure slide (12). The manure displacing device (2) is further provided with pressure setting means (9) for determining the force with which the manure displacing device (2) is active on a stable floor.

The invention relates to an unmanned vehicle which is adapted to be used in a stable, such as a cowshed.

Such a vehicle is known.

The known vehicle is provided at its front side with a manure slide by means of which the grid floor of a stable is cleaned.

The known vehicle has the disadvantage that parts of the stable which are difficult to reach, such as e.g. cubicles, cannot be cleaned by the vehicle.

It is an objective of the intention to make the unmanned vehicle suitable for cleaning also places in the stable which are difficult to reach.

In accordance with the invention, this is achieved in that the vehicle is provided with a manure displacing device which is capable of being moved to a place at a distance from the vehicle. Because of the fact that the manure displacing device is disposed at a distance from the unmanned vehicle and/or is capable of being moved to a place at a distance from said vehicle, it is possible to clean places in the stable which are difficult to reach, such as e.g. cubicles, without the vehicle needing to move to these places. According to a further inventive feature, the manure displacing device comprises a windable carrier, one end of which is connected to a manure displacing member and whose other end is connected to the unmanned vehicle. The windable carrier has the advantage of occupying relatively little space, thus making it possible for the unmanned vehicle to be equipped with some more apparatuses.

According to a first embodiment of the invention, the windable carrier comprises at least one cable caterpillar. Such a cable caterpillar is used for storing cables and is employed e.g. in an industrial robot arm construction, such as a welding robot. One of the properties of such a cable caterpillar is that during movement of the robot arm construction the cables do not kink, but make a smooth curve. Another property of such a cable caterpillar is that it can only be wound in one direction, because the links of the cable caterpillar are blocked in the other direction. The latter property makes it possible to use the cable caterpillar as a rigid carrier for the manure displacing device. According to a second embodiment of the invention, the windable carrier comprises two cable caterpillars which are disposed one on top of the other. By placing two cable caterpillars on top of each other the entire carrier becomes rigid in all directions, while it still remains possible to wind or unwind the two caterpillars.

In accordance with a third embodiment of the invention, the windable carrier is constituted by a resilient strip material. In a preferred embodiment of the invention, the material is constituted by spring steel. For the purpose of making it possible for the windable carrier/carriers to be wound or unwound, they are disposed on a reel. Said reel is motor-driven for winding and unwinding the windable carrier. According to a further inventive feature, the manure displacing device comprises a telescopic carrier and/or a hingeable arm construction. In accordance with an inventive feature, the manure displacing device comprises a manure slide which is preferably made of rubber or synthetic material. According to again another inventive feature, it is also possible to provide the manure displacing device with motor-drivable manure displacing members. The motor-drivable manure displacing members have the advantage that, during cleaning, they do not need to be pressed on the stable floor with considerable force, like a manure slide. According to a further inventive feature, the manure displacing members are constituted by brushes. It is also possible for the manure displacing device to comprise a compressed air unit and/or a spraying unit by means of which the floor is cleaned with compressed air and/or liquid.

For the purpose of realizing a still better cleaning of the stable floor, according to an inventive feature, the manure displacing device comprises pressure setting means with the aid of which the force is set with which the manure displacing device is active on the stable floor. In accordance with a further inventive feature, the pressure setting means comprise a control cylinder. The pressure setting means are also used for positioning the manure displacing device.

In accordance with another aspect of the invention, the manure displacing device forms part of a wall of the unmanned vehicle. For the purpose of determining where in the stable there has to be cleaned, according to an inventive feature, the unmanned vehicle comprises detection means which are capable of observing the dirt present on the stable floor. According to a further inventive feature, the detection means comprise a camera, such as e.g. an infrared camera. It is further possible for the detection means to comprise a humidity meter with the aid of which the electric conductivity on a floor part in the stable is determined. By means of a dielectric measurement it is possible to determine whether the stable floor is contaminated with manure.

According to again another inventive feature, the unmanned vehicle comprises a second manure displacing device which is disposed under the vehicle. According to the invention, the second manure displacing device constitutes a support for the vehicle.

For the purpose of operating in a still more hygienic manner, the unmanned vehicle comprises cleaning and/or disinfecting means. According to a further inventive feature, the cleaning and/or disinfecting means comprise a spraying unit. With the aid of the spraying unit it is possible to spray a cleaning and/or a disinfecting liquid over the already cleaned stable floor. According to the invention, a favourable location for the cleaning and/or disinfecting means is on or near the manure displacing device. For the purpose of preventing the animals from damaging the unmanned vehicle, according to an inventive feature, the unmanned vehicle comprises signalling means which are adapted to keep animals at a distance from the unmanned vehicle. According to a further inventive feature, the signalling means are capable of emitting optical and/or acoustic signals. According to again another inventive feature, the signalling means comprise an electric shock device.

The invention will now be explained in further detail with reference to the accompanying drawings.

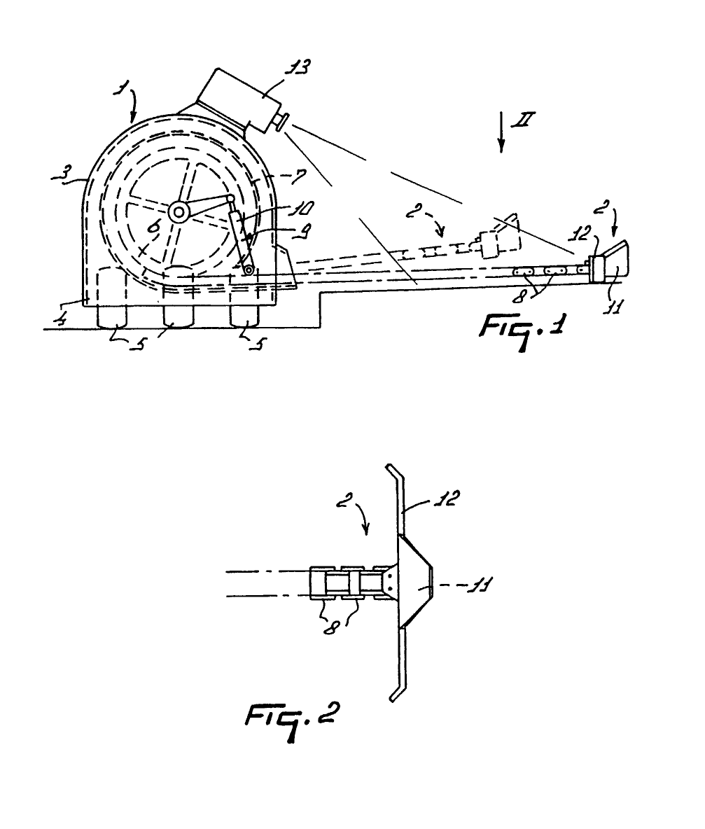

FIG. 1 is a side view of the unmanned vehicle according to the invention, which vehicle is provided with a manure displacing device, and

FIG. 2 is a plan view of the manure displacing device shown in FIG. 1.

FIG. 1 is a side view of a first unmanned vehicle 1 which is provided with a manure displacing device 2. The unmanned vehicle 1 comprises a housing 3 with a chassis 4 which is provided with wheels 5. The wheels 5 can separately be driven by non-shown motors.

In the housing 3 there is further arranged a reel 6 on which a windable carrier 7 is wound. In the present embodiment the windable carrier 7 is constituted by a cable caterpillar. One end of the cable caterpillar 7 is connected to the reel 6 and and its other end is connected to the manure displacing device 2. As shown in FIGS. 1 and 2, the cable caterpillar 7 comprises links 8 which are capable of hinging in one direction relative to each other.

The manure displacing device 2 is further provided with pressure setting means 9 with the aid of which the cable caterpillar can be lifted. In the present embodiment the pressure setting means 9 are constituted by a control cylinder 10. The pressure setting means 9 are also used for positioning the manure displacing device 2. Positioning of the manure displacing device 2 is effected by lifting the cable caterpillar 7 by means of the control cylinder 10 and by unwinding the cable caterpillar 7 by means of the reel 6 until it has reached the intended destination, whereupon the cable caterpillar 7 is moved to the stable floor by means of the control cylinder 10.

Because of the fact that a weight 11 is disposed on the manure displacing device 2 there is obtained sufficient pressure on the manure slide 12 belonging to the manure displacing device 2 to displace the manure over the floor. Displacing the manure over the floor takes place by winding up the cable caterpillar 7 by means of the reel 6.

On the housing 3 of the unmanned vehicle 1 there are further disposed detection means 13 with the aid of which dirt, such as manure, on the stable floor can be traced. In the present embodiment the detection means 13 comprise a camera. It is also possible to guide the unmanned vehicle 1 through the stable with the aid of the detection means 13.

1. An unmanned vehicle (1) which is adapted to be used in a stable, such as a cowshed, characterized in that the unmanned vehicle (1) is provided with a manure displacing device (2) which is capable of being moved to a place at a distance from the vehicle.

2. An unmanned vehicle as claimed in claim 1, characterized in that the manure displacing device (2) comprises a windable carrier (7), one end of which is connected to a manure displacing member (2) and whose other end is connected to the unmanned vehicle (1).

3. An unmanned vehicle as claimed in claim 2, characterized in that the windable carrier (7) comprises at least one cable caterpillar.

4. An unmanned vehicle as claimed in claim 3, characterized in that the windable carrier (7) comprises two cable caterpillars which are disposed one on top of the other.

5. An unmanned vehicle as claimed in claim 2, characterized in that the windable carrier (7) is constituted by a resilient strip material.

6. An unmanned vehicle as claimed in claim 5, characterized in that the material is constituted by spring steel.

7. An unmanned vehicle as claimed in any one of claims 2 to 6, characterized in that the windable carrier (7) is disposed on a reel (6).

8. An unmanned vehicle as claimed in claim 7, characterized in that the reel (6) is motor-drivable for winding and unwinding the carrier.

9. An unmanned vehicle as claimed in any one of the preceding claims, characterized in that the manure displacing device (2) comprises a manure slide (12) which is preferably made of rubber or synthetic material.

10. An unmanned vehicle as claimed in any one of the preceding claims, characterized in that the manure displacing device (2) comprises motor-drivable manure displacing members and/or a spraying unit and/or a compressed air unit.

11. An unmanned vehicle as claimed in claim 10, characterized in that the manure displacing members are constituted by brushes.

12. An unmanned vehicle as claimed in any one of the preceding claims, characterized in that the manure displacing device (2) comprises pressure setting means (9) for setting the force with which the manure displacing device (2) is active on a floor.

13. An unmanned vehicle as claimed in claim 12, characterized in that the pressure setting means (9) comprise a control cylinder (10).

14. An unmanned vehicle as claimed in any one of the preceding claims, characterized in that the manure displacing device (2) forms part of a wall of the unmanned vehicle (1).

15. An unmanned vehicle as claimed in any one of the preceding claims, characterized in that the unmanned vehicle (1) comprises detection means (13) for determining whether and/or where manure and/or any other dirt are/is present on the stable floor.

16. An unmanned vehicle as claimed in claim 15, characterized in that the detection means (13) comprise a camera, such as e.g. an infrared camera.

17. An unmanned vehicle as claimed in claim 15 or 16, characterized in that the detection means comprise a humidity meter for determining the electric conductivity on a floor part in the stable.

18. An unmanned vehicle as claimed in any one of the preceding claims, characterized in that the unmanned vehicle (1) comprises a second manure displacing device which is disposed under the vehicle.

19. An unmanned vehicle as claimed in any one of the preceding claims, characterized in that the second manure displacing device constitutes a support for the vehicle.

20. An unmanned vehicle as claimed in any one of the preceding claims, characterized in that the unmanned vehicle (1) comprises cleaning and/or disinfecting means.

21. An unmanned vehicle as claimed in claim 20, characterized in that the cleaning and/or disinfecting means comprise a spraying unit.

22. An unmanned vehicle as claimed in claim 20 or 21, characterized in that the cleaning and/or disinfecting means are disposed on the manure displacing device (2).

23. An unmanned vehicle as claimed in any one of the preceding claims, characterized in that the unmanned vehicle (1) comprises signalling means which are adapted to keep the animals at a distance from the unmanned vehicle.

24. An unmanned vehicle as claimed in claim 23, characterized in that the signalling means emit optical and/or acoustic signals.

25. An unmanned vehicle as claimed in claim 23 or 24, characterized in that the signalling means comprise an electric shock device.

26. A method of displacing manure over a stable floor by means of an unmanned vehicle provided with a manure displacing device as claimed in any one of claims 1 to 25, in which method the unmanned vehicle and/or the stable are/is provided with detection means for determining whether an animal has visited a cubicle after the relevant cubicle has been cleaned by means of the manure displacing device, and the detection means emit a control signal to the unmanned vehicle when the relevant animal has left the cubicle, on the basis of which control signal the unmanned vehicle cleans the relevant cubicle with the aid of the manure displacing means.
